(19) United States
(12) Patent Application Publication
(10) Pub. No.: US 2022/0098374 A1
(43) Pub. Date: Mar. 31, 2022

(54) CROSSLINKED FLUORESCENT LATEXES

(71) Applicant: Xerox Corporation, Norwalk, CT (US)

(72) Inventors: Chunliang Lu, Webster, NY (US); Peter V. Nguyen, Webster, NY (US)

(21) Appl. No.: 17/038,092

(22) Filed: Sep. 30, 2020

(51) Int. Cl. C08J 3/26; C08F 220/12; G03G 9/08; G03G 15/20

(52) U.S. Cl. CPC C08J 3/26; C08F 220/12; C08J 2313/02; G03G 9/0804; G03G 15/20; G03G 9/081

(57) ABSTRACT

Methods of making a crosslinked fluorescent latex are provided. In an embodiment, such a method comprises adding a water-soluble initiator to an uncrosslinked fluorescent latex comprising water and uncrosslinked resin particles comprising an unsaturated resin and a fluorescent agent incorporated therein; and exposing the water-soluble initiator to conditions to activate the water-soluble initiator and induce crosslinking reactions between the activated water-soluble initiator and the unsaturated resin, thereby forming a crosslinked fluorescent latex comprising crosslinked fluorescent resin particles comprising crosslinked resin and the fluorescent agent incorporated therein. Crosslinked fluorescent latexes are also provided, as are fluorescent toners made from the same.

### BACKGROUND

Fluorescent toners have been developed in order to extend the capabilities of existing xerographic printing systems based on cyan, magenta, yellow, and black (CMYK) toner stations. However, fluorescent toners are more challenging to print using as compared to CMYK toners. For example, when passing through the fuser roll members of xerographic printing systems, the fluorescent agents can contact the fuser roll, which leads to unacceptable, long-lasting contamination.

### SUMMARY

The present disclosure provides crosslinked fluorescent latexes and compositions formed from the crosslinked fluorescent latexes, such as toners and inkjet printing compositions. Related methods are also provided.

Methods of making a crosslinked fluorescent latex are provided. In an embodiment, such a method comprises adding a water-soluble initiator to an uncrosslinked fluorescent latex comprising water and uncrosslinked resin particles comprising an unsaturated resin and a fluorescent agent incorporated therein; and exposing the water-soluble initiator to conditions to activate the water-soluble initiator and induce crosslinking reactions between the activated water-soluble initiator and the unsaturated resin, thereby forming a crosslinked fluorescent latex comprising crosslinked fluorescent resin particles comprising crosslinked resin and the fluorescent agent incorporated therein.

Crosslinked fluorescent latexes are also provided. In an embodiment, such a latex comprises water and crosslinked fluorescent resin particles comprising crosslinked resin and a fluorescent agent incorporated therein, wherein the crosslinked fluorescent latex is characterized by a degree of crosslinking n of no more than 0.50 over range of frequencies from 0.100 to 1.000 rad/s as determined from a rheology sweep test at 120° C.

Fluorescent toners are also provided. In an embodiment, such a toner comprises particles comprising uncrosslinked resin and crosslinked fluorescent resin particles comprising crosslinked resin and a fluorescent agent incorporated therein, wherein the crosslinked fluorescent resin particles are characterized by a degree of crosslinking n of no more than 0.50 over range of frequencies from 0.100 to 1.000 rad/s as determined from a rheology sweep test at 120° C.

### DETAILED DESCRIPTION

The present disclosure provides crosslinked fluorescent latexes and compositions formed from the crosslinked fluorescent latexes, such as toners and inkjet printing compositions. Related methods are also provided.

The present crosslinked fluorescent latexes comprise crosslinked resin particles having incorporated therein a fluorescent agent. Although some crosslinked fluorescent latexes for toners have been developed, it has been challenging to achieve a high degree of crosslinking without negatively affecting optical properties (e.g., brightness). The present disclosure is based, at least in part, on the use of water-soluble initiators to induce crosslinking and an improved process for forming the crosslinked fluorescent latexes. The result is a highly crosslinked, very bright fluorescent latex. These latexes may be used to form toners for use in xerographic printing systems which do not contaminate the fuser roll members during printing. This greatly extends the life of the fuser roll members as compared to uncrosslinked or even lightly crosslinked fluorescent latexes.

Fluorescent Agents

As noted above, the present crosslinked fluorescent latexes comprise a fluorescent agent. Fluorescent agents include fluorescent brighteners and fluorescent dyes. Illustrative fluorescent brighteners include the following: Fluorescent Brightener 184, Optical Brightener 1 (Fluorescent Brightening Agent 393), Optical Brightener 2, Optical Brightener 3, Optical Brightener C, Optical Brightener OB, Optical Brightener Tinopal CBS-X, 378, 367, 368, 185, 199, 199:1, 199:2, Optical Brightener ER-IV, Optical Brightener ER-V, Fluorescent Brightening Agent 369 OB. In embodiments, the fluorescent brightener is Fluorescent Brightener 184. Illustrative fluorescent dyes include the following: Solvent Yellow 160:1, Solvent Yellow 98, Solvent Yellow 43, Basic Yellow 40, Solvent Yellow 3G, Solvent Green 5, D&C Red #21, D&C Orange #5, Pylam Oil FL Red, Pylam Oil FL Purple, Solvent Red #49 (Rhodamine B base), Solvent Red 149, Solvent Red 196, Solvent Red 197, Solvent Orange 115, Solvent Orange 63, Pylam Green LX11862, Pylam Lime Green 1211141, Basic Violet 11:1, Basic Red 1, Rhodamine B, D&C Red #27. In embodiments, the fluorescent dye is Solvent Yellow 160:1, Solvent Yellow 98, Solvent Yellow 43, Basic Yellow 40, Solvent Red 49, or combinations thereof. Combinations of different types of fluorescent brighteners and different types of fluorescent dyes may be used.

The total amount of the fluorescent agents may be present in the crosslinked fluorescent latex in an amount of, for example, from 0.1 weight % to 10 weight % by weight of the crosslinked fluorescent latex. This includes a total amount of from 0.1 weight % to 8 weight %, from 0.2 weight % to 6 weight %, from 0.5 weight % to 5 weight %, and from 1 weight % to 2 weight %.

Resins

The resin particles of the present crosslinked fluorescent latexes provide a polymeric matrix to contain the fluorescent agent(s). The term “resin” is distinguished from the term “monomers,” the molecular component which is polymerized to form the resin. The resin particles may comprise more than one different type of resin. The resin may be an amorphous resin, a crystalline resin, a mixture of amorphous resins, or a mixture of crystalline and amorphous resins. The resin may be a polyester resin, including an amorphous polyester resin, a crystalline polyester resin, a mixture of amorphous polyester resins, or a mixture of crystalline and amorphous polyester resins. In order to allow for crosslinking, at least one of the resins is an unsaturated resin. It is noted that this section also describes resins which may be included in compositions formed from the present fluorescent latexes, e.g., toners.

Crystalline Resin

The resin may be a crystalline polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, combinations thereof, and the like including their structural isomers. The aliphatic diol may be, for example, selected in an amount of from about 40 to about 60 mole percent of the resin, from about 42 to about 55 mole percent of the resin, or from about 45 to about 53 mole percent of the resin, and a second diol may be selected in an amount of from about 0 to about 10 mole percent of the resin or from about 1 to about 4 mole percent of the resin.

Examples of organic diacids or diesters including vinyl diacids or vinyl diesters selected for the preparation of crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof. The organic diacid may be selected in an amount of, for example, from about 40 to about 60 mole percent of the resin, from about 42 to about 52 mole percent of the resin, or from about 45 to about 50 mole percent of the resin, and a second diacid can be selected in an amount of from about 0 to about 10 mole percent of the resin.

Polycondensation catalysts which may be utilized in forming crystalline (as well as amorphous) polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate), and mixtures thereof. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), poly(propylene-sebecamide), and mixtures thereof. Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), poly(butylene-succinimide), and mixtures thereof.

In embodiments, the crystalline polyester resin has the following formula (I)

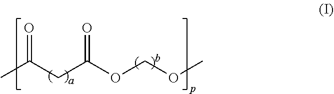

wherein each of a and b may range from 1 to 12, from 2 to 12, or from 4 to 12 and further wherein p may range from 10 to 100, from 20 to 80, or from 30 to 60. In embodiments, the crystalline polyester resin is poly(1,6-hexylene-1,12-dodecanoate), which may be generated by the reaction of dodecanedioc acid and 1,6-hexanediol.

As noted above, the disclosed crystalline polyester resins may be prepared by a polycondensation process by reacting suitable organic diols and suitable organic diacids in the presence of polycondensation catalysts. A stoichiometric equimolar ratio of organic diol and organic diacid may be utilized, however, in some instances where the boiling point of the organic diol is from about 180° C. to about 230° C., an excess amount of diol, such as ethylene glycol or propylene glycol, of from about 0.2 to 1 mole equivalent, can be utilized and removed during the polycondensation process by distillation. The amount of catalyst utilized may vary, and can be selected in amounts, such as for example, from about 0.01 to about 1 or from about 0.1 to about 0.75 mole percent of the crystalline polyester resin.

The crystalline resin can possess various melting points of, for example, from about 30° C. to about 120° C., from about 50° C. to about 90° C., or from about 60° C. to about 80° C. The crystalline resin may have a number average molecular weight (Mₙ), as measured by gel permeation chromatography (GPC) of, for example, from about 1,000 to about 50,000, from about 2,000 to about 25,000, or from about 5,000 to about 20,000, and a weight average molecular weight (M_{w}) of, for example, from about 2,000 to about 100,000, from about 3,000 to about 80,000, or from about 10,000 to about 30,000, as determined by GPC. The molecular weight distribution (M_{w}/Mₙ) of the crystalline resin may be, for example, from about 2 to about 6, from about 3 to about 5, or from about 2 to about 4.

Amorphous Resin

The resin may be an amorphous polyester resin formed by reacting a diol with a diacid in the presence of an optional catalyst. Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, trimellitic acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethyl succinate, dimethylfumarate, dimethylmaleate, dimethylglutarate, dimethyladipate, dimethyl dodecylsuccinate, and combinations thereof. The organic diacids or diesters may be present, for example, in an amount from about 40 to about 60 mole percent of the resin, from about 42 to about 52 mole percent of the resin, or from about 45 to about 50 mole percent of the resin.

Examples of diols which may be utilized in generating an amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diols selected may vary, for example, the organic diols may be present in an amount from about 40 to about 60 mole percent of the resin, from about 42 to about 55 mole percent of the resin, or from about 45 to about 53 mole percent of the resin.

Examples of suitable amorphous resins include polyesters, polyamides, polyimides, polyolefins, polyethylene, polybutylene, polyisobutyrate, ethylene-propylene copolymers, ethylene-vinyl acetate copolymers, polypropylene, and the like, and mixtures thereof.

An unsaturated amorphous polyester resin may be utilized as a resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

A suitable polyester resin may be an amorphous polyester such as a poly(propoxylated bisphenol A co-fumarate) resin. Examples of such resins and processes for their production include those disclosed in U.S. Pat. No. 6,063,827, the disclosure of which is hereby incorporated by reference in its entirety.

Suitable polyester resins include amorphous acidic polyester resins. An amorphous acid polyester resin may be based on any combination of propoxylated bisphenol A, ethoxylated bisphenol A, terephthalic acid, fumaric acid, and dodecenyl succinic anhydride, such as poly(propoxylated bisphenol-co-terephthlate-fumarate-dodecenylsuccinate). Another amorphous acid polyester resin which may be used is poly(propoxylated-ethoxylated bisphenol-co-terephthalate-dodecenylsuccinate-trimellitic anhydride).

An example of a linear propoxylated bisphenol A fumarate resin which may be utilized as a resin is available under the trade name SPAMII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

The amorphous resin or combination of amorphous resins may have a glass transition temperature of from about 30° C. to about 80° C., from about 35° C. to about 70° C., or from about 40° C. to about 65° C. The glass transition temperature may be measured using differential scanning calorimetry (DSC). The amorphous resin may have a Mₙ, as measured by GPC of, for example, from about 1,000 to about 50,000, from about 2,000 to about 25,000, or from about 1,000 to about 10,000, and a M_{w} of, for example, from about 2,000 to about 100,000, from about 5,000 to about 90,000, from about 10,000 to about 90,000, from about 10,000 to about 30,000, or from about 70,000 to about 100,000, as determined by GPC.

The resin(s) in the present toners may possess acid groups which may be present at the terminal of the resin. Acid groups which may be present include carboxylic acid groups, and the like. The number of carboxylic acid groups may be controlled by adjusting the materials utilized to form the resin and reaction conditions. In embodiments, the resin is a polyester resin having an acid number from about 2 mg KOH/g of resin to about 200 mg KOH/g of resin, from about 5 mg KOH/g of resin to about 50 mg KOH/g of resin, or from about 5 mg KOH/g of resin to about 15 mg KOH/g of resin. The acid containing resin may be dissolved in tetrahydrofuran solution. The acid number may be detected by titration with KOH/methanol solution containing phenolphthalein as the indicator. The acid number may then be calculated based on the equivalent amount of KOH/methanol required to neutralize all the acid groups on the resin identified as the end point of the titration.

The present crosslinked fluorescent latex may comprise a single type of resin, e.g., a single type of amorphous polyester resin, or multiple types of resins, e.g., two different types of amorphous polyester resins. In such embodiments, one of the amorphous polyester resins has an Mₙ or M_{w} that is greater than the other. In embodiments in which two different types of amorphous polyester resins are used, the weight ratio of the two types may be from 2:3 to 3:2. This includes a weight ratio of 1:1. Alternatively, two separate crosslinked fluorescent latexes may be used, each comprising a different type of amorphous polyester resin. However, together, the crosslinked fluorescent latex(es) provide the two different types of amorphous polyester resins within this range of weight ratios.

The total amount of the resins may be present in the crosslinked fluorescent latex in an amount of, for example, from 1 weight % to 60 weight % by weight of the crosslinked fluorescent latex. This includes total amounts of resin in a range of from 5 weight % to 50 weight % and from 10 weight % to 40 weight %.

As noted above, the form of the fluorescent agent-incorporated, crosslinked resins is that of particles. The particles may have an average size in a range of from 20 nm to 1000 nm, as measured by dynamic light scattering.

Other Components

The present crosslinked fluorescent latexes generally further comprise one or more solvents, although they may also be utilized in a dried form. Water is typically used as a solvent, but organic solvent(s) may be included. Other components may be included, e.g., one or more types of defoamers, one or more types of surfactants, one or more types of biocides. Surfactants include sodium dodecyl sulfate, Calfax/Dowfax, sodium dioctyl sulfosuccinate, sodium dodecylbenzene sulfonate, etc. Biocides include Proxel GXL, Kathon biocides, Bioban preservatives, Rocima 586 Microblade, Ucarcide Antimicrobials, Dowicide Antimicrobials, etc.

Crosslinked Fluorescent Latex Preparation

The fluorescent agent-incorporated, crosslinked resin particles and the crosslinked fluorescent latexes comprising the particles may be prepared as follows. A mixture may be formed by combining the desired fluorescent agent, the desired resin, and a solvent. The solvent may be a solvent system comprising one or more organic solvents (acetone, tetrahydrofuran, ethyl acetate, methyl ethyl ketone, methylene chloride, methanol, ethanol, n-propyl alcohol, isopropyl alcohol, butanol, etc.) as well as water. Other additives may be included in the mixture, e.g., one or more types of surfactants (see “Other Components,” above) and one or more types of base (sodium hydroxide, potassium hydroxide, ammonia, triethyl amine, sodium bicarbonate, etc.) As noted above, the desired fluorescent agent may include one or more types of the fluorescent brighteners, one or more types of the fluorescent dyes, and the desired resin may include more than one type of resin. If more than one type of fluorescent agent is used, they may be included in the same fluorescent latex. However, separate fluorescent latexes may also be prepared and used, e.g., one fluorescent latex comprising one type of fluorescent agent and another fluorescent latex comprising another type of fluorescent agent. The resulting fluorescent agent/resin/solvent mixture is heated to a temperature (e.g., from 30° C. to 80° C., 40° C. to 75° C., 45° C. to 70° C.) and for a time (e.g., 20 minutes to 5 hours, 30 minutes to 2 hours, 1 hour) while mixing to homogenize the mixture. Additional base may be added to neutralize the resin while mixing. Mixing is carried out to ensure homogenization and to provide fluorescent agent-incorporated resin particles having a desired size. (Mixing and homogenization is further described below with respect to toners.) An amount of surfactant, and/or a biocide may be added. Finally, organic solvents may be removed by distillation. Water may be added during this process to keep the desired solid content.

The resulting fluorescent latex provided by the process described above is uncrosslinked. To crosslink the fluorescent agent-incorporated resin particles, a water-soluble initiator is added to the uncrosslinked fluorescent latex. A variety of types of water-soluble initiators may be used, including persulfates. Suitable persulfates include potassium persulfate, sodium persulfate, and ammonium persulfate. The amount of the water-soluble initiator may be in a range of from 0.2 weight % to 3 weight % by weight of the resin in the uncrosslinked fluorescent latex. This includes from 0.5 weight % to 2 weight % and from 1 weight % to 1.5 weight % by weight of the resin in the uncrosslinked fluorescent latex. Next, the mixture is exposed to conditions to activate the initiator and induce crosslinking reactions between the activated initiator and an unsaturated resin of the uncrosslinked fluorescent latex. These conditions depend upon the type of initiator used. They may include heating to a temperature (e.g., from 60° C. to 98° C., from 65° C. to 95° C., from 70° C. to 80° C.) and for a time (e.g., 20 minutes to 5 hours, 30 minutes to 3 hours, 1 to 2 hours) while mixing. The heating/mixing may take place under an inert gas (e.g., N₂). During crosslinking, a pH control agent may be added to maintain neutral or basic conditions, e.g., greater than pH 6. Alternatively, additional surfactant may be added. Both are useful to minimize/prevent agglomeration of resin particles. The result is a crosslinked fluorescent latex.

Water-soluble initiators, which are soluble in water (e.g., having a solubility of more than 0.5 g/100 mL in water at 25° C.), are distinguished from oil-soluble initiators, which are soluble in an organic solvent, and have very limited water solubilities (e.g., having a solubility of less than 0.1 g/100 mL in water at 25° C.). Oil-soluble initiators include, e.g., azo initiators and peroxide initiators.

It has been found that by using the process described above, involving already polymerized (but unsaturated) resin (as opposed to monomers) and water-soluble initiators (as opposed to oil-soluble initiators), high degrees of crosslinking may be achieved. The degree of crosslinking may be determined through rheology frequency sweep tests as described in the Example below. Such a test measures storage modulus G′ as a function of frequency ω. At low frequencies, G′∝ωⁿ, wherein the power n represents the degree of crosslinking. Linear polymers have n˜2, lightly crosslinked polymers have n˜1, and fully crosslinked polymers have n˜0. Highly crosslinked polymers haven in a range of from 0 to 0.5. In embodiments, the present crosslinked fluorescent latex is characterized by n of no more than 0.5, no more than 0.4, no more than 0.3, no more than 0.2, no more than 0.15, no more than 0.05, or in a range of from 0 to 0.5. These values may refer to a particular temperature, e.g., 120° C., and a range of frequencies, e.g., from 0.100 to 1.000 rad/s. As described in the Example, below, these values are unexpectedly low (i.e., the crosslinking is unexpectedly high) as compared to crosslinking induced by oil-soluble initiators.

At the same time, the present crosslinked fluorescent latexes are highly fluorescent. The fluorescence of the crosslinked fluorescent latexes may be confirmed and quantified using a spectrodensitometer (such as Hunter, X-Rite, etc.) or a fluorescence spectrometer, operated in accordance with the manufacturer's instructions. These systems may also be used to measure reflectance spectra (reflectance versus wavelength). The crosslinked fluorescent latexes may be characterized by a peak reflectance value (i.e., reflectance value at the peak in a reflectance spectrum). This peak reflectance value may be the same (i.e., within ±5%, ±2%, ±1%) as compared to a comparative uncrosslinked fluorescent latex having the same fluorescent agent and made by the same process except without crosslinking. This result shows that crosslinking process does not negatively affect the optical properties of the crosslinked fluorescent latex.

The present crosslinked fluorescent latexes may be used to form any kind of composition in which fluorescence is desired. Illustrative compositions include toners and inkjet printing compositions, thereby rendering such compositions fluorescent. These illustrative compositions are further described below.

Toners

In order to form the present toners, any of the resins described above may be provided as an emulsion(s), e.g., by using a solvent-based phase inversion emulsification process. The emulsions may then be utilized as the raw materials to form the toners, e.g., by using an emulsion aggregation and coalescence (EA) process. However, the toners may be prepared using other processes. As noted above, any of the crosslinked fluorescent latexes described above may be used in the toner preparation process to form fluorescent toners.

The toner may also include a wax, which may be incorporated into the toner as a separate dispersion of the wax in water. In addition to the fluorescent agent provided by the crosslinked fluorescent latex, the toner may also include a non-fluorescent colorant, e.g., a pigment.

Wax

Optionally, a wax may be included in the present toners. A single type of wax or a mixture of two or more different waxes may be used. A single wax may be added, for example, to improve particular toner properties, such as toner particle shape, presence and amount of wax on the toner particle surface, charging and/or fusing characteristics, gloss, stripping, offset properties, and the like. Alternatively, a combination of waxes can be added to provide multiple properties to the toner composition.

When included, the wax may be present in an amount of, for example, from 1 weight % to 25 weight % by weight of the toner or from 5 weight % to 20 weight % by weight of the toner particles.

When a wax is used, the wax may include any of the various waxes conventionally used in emulsion aggregation toners. Waxes that may be selected include waxes having, for example, an average molecular weight of from about 500 to about 20,000 or from about 1,000 to about 10,000. Waxes that may be used include, for example, polyolefins such as polyethylene including linear polyethylene waxes and branched polyethylene waxes, polypropylene including linear polypropylene waxes and branched polypropylene waxes, polymethylene waxes, polyethylene/amide, polyethylenetetrafluoroethylene, polyethylenetetrafluoroethylene/amide, and polybutene waxes such as commercially available from Allied Chemical and Petrolite Corporation, for example POLYWAX™ polyethylene waxes such as commercially available from Baker Petrolite, wax emulsions available from Michaelman, Inc. and the Daniels Products Company, EPOLENEN15™ commercially available from Eastman Chemical Products, Inc., and VISCOL550P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax such as waxes derived from distillation of crude oil, silicone waxes, mercapto waxes, polyester waxes, urethane waxes; modified polyolefin waxes (such as a carboxylic acid-terminated polyethylene wax or a carboxylic acid-terminated polypropylene wax); Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethylene glycol monostearate, dipropylene glycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP6550™, SUPERSLIP6530™ available from Micro Powder Inc., fluorinated waxes, for example POLYFLUO190™, POLYFLUO200™, POLYSILK 19™, POLYSILK14™ available from Micro Powder Inc., mixed fluorinated, amide waxes, such as aliphatic polar amide functionalized waxes; aliphatic waxes consisting of esters of hydroxylated unsaturated fatty acids, for example MICROSPERSION19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

Colorant

Optionally, a colorant (other than the disclosed fluorescent agents) may be included in the present toners. The colorant may be present in an amount of, for example, from 0% to 25% by weight of the toner, from 1% to 20% by weight of the toner, or from 2% to 15% by weight of the toner.

Carbon black, which is available in forms, such as furnace black, thermal black, and the like is a suitable colorant. Carbon black may be used with one or more other colorants, such as a cyan colorant.

Examples of cyan pigments include copper tetra(octadecylsulfonamido) phthalocyanine, a copper phthalocyanine colorant listed in the Color Index (CI) as CI 74160, HELIOGEN BLUE L6900™, D6840™, D7080™, D7020™, PYLAM OIL BLUE™, PYLAM OIL YELLOW™ and PIGMENT BLUE I™ available from Paul Uhlich & Co., Inc., CI Pigment Blue (PB), PB 15:3, PB 15:4, an Anthrazine Blue colorant identified as CI 69810, Special Blue X-2137, mixtures thereof, and the like.

Examples of magenta pigments include a diazo dye identified as C.I. 26050, 2,9-dimethyl-substituted quinacridone, an anthraquinone dye identified as C.I. 60710, C.I. Dispersed Red 15, CINQUASIA MAGENTA™ available from E.I. DuPont de Nemours & Co., C.I. Solvent Red 19, Pigment Red (PR) 122, PR 269, PR 185, mixtures thereof, and the like.

Examples of yellow colorants include diarylide yellow 3,3-dichlorobenzidene acetoacetanilide, a monoazo pigment identified in the Color Index as C.I. 12700, C.I. Solvent Yellow 16, a nitrophenyl amine sulfonamide identified in the Color Index as Foron Yellow SE/GLN, LEMON CHROME YELLOW DCC1026™ CI, NOVAPERM YELLOW FGL™ from sanofi, Paliogen Yellow 152, 1560 (BASF), Lithol Fast Yellow 0991K (BASF), Paliotol Yellow 1840 (BASF), Neopen Yellow (BASF), Novoperm Yellow FG 1 (sanofi), Permanent Yellow YE 0305 (Paul Uhlich), Pigment Yellow 74, Lumogen Yellow D0790 (BASF), Sunsperse Yellow YHD 6001 (Sun Chemicals), SUCD-Yellow D1355 (BASF), Permanent Yellow FGL, Disperse Yellow, 3,2,5-dimethoxy-4-sulfonanilide phenylazo-4′-chloro-2,5-dimethoxy acetoacetanilide, mixtures thereof, and the like.

In embodiments, the toner is prepared by an EA process, such as by aggregating a mixture of an emulsion comprising a resin; the fluorescent agent (provided as one or more crosslinked fluorescent latexes); optionally, a wax (provided as a separate dispersion); and optionally, a colorant (provided as a separate dispersion) and then coalescing the mixture. The emulsion comprising the resin may comprise one or more resins or different resins may be provided as different emulsions. The emulsion(s) comprising the resin generally do not comprise and thus, are free of the fluorescent agents. In addition, this resin is generally uncrosslinked. In the EA process, the fluorescent agent(s) are provided as the one or more crosslinked fluorescent latexes, separate from the other components of the mixture and as opposed to simply adding the fluorescent agents themselves to the mixture.

Next, the mixture may be homogenized which may be accomplished by mixing at about 600 to about 6,000 revolutions per minute (rpm). Homogenization may be accomplished by any suitable means, including, for example, an IKA ULTRA TURRAX T50 probe homogenizer. An aggregating agent may be added to the mixture. Any suitable aggregating agent may be utilized. Suitable aggregating agents include, for example, aqueous solutions of a divalent cation or a multivalent cation material. The aggregating agent may be, for example, an inorganic cationic aggregating agent such as a polyaluminum halide such as polyaluminum chloride (PAC), or the corresponding bromide, fluoride, or iodide; a polyaluminum silicate such as polyaluminum sulfosilicate (PASS); or a water soluble metal salt including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, and copper sulfate; or combinations thereof. The aggregating agent may be added to the mixture at a temperature that is below the glass transition temperature (T_{g}) of the resin (s). The aggregating agent may be added to the mixture under homogenization.

The aggregating agent may be added to the mixture in an amount of, for example, from 0 weight % to 10 weight % by weight of the total amount of resin, from 0.2 weight % to 8 weight % by weight of the total amount of resin, or from 0.5 weight % to 5 weight % by weight of the total amount of resin.

The particles of the mixture may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for volume average particle size. The aggregation thus may proceed by maintaining an elevated temperature, or slowly raising the temperature to, for example, in embodiments, from about 30° C. to about 100° C., in embodiments from about 30° C. to about 80° C., or in embodiments from about 30° C. to about 50° C. The temperature may be held for a period time of from about 0.5 hours to about 6 hours, or in embodiments from about hour 1 to about 5 hours, while stirring, to provide the aggregated particles. Once the predetermined desired particle size is reached, a shell may be added (although a shell is not required). The volume average particle size of the particles prior to application of a shell may be, for example, from about 3 μm to about 10 μm, in embodiments, from about 4 μm to about 9 μm, or from about 6 μm to about 8 μm.

Shell Resin

After aggregation, but prior to coalescence, a resin coating may be applied to the aggregated particles to form a shell thereover. Any of the resins described above may be utilized in the shell. In embodiments, an amorphous polyester resin is utilized in the shell. In embodiments, two amorphous polyester resins (of different types) are utilized in the shell. In embodiments, a crystalline polyester resin and two different types of amorphous polyester resins are utilized in the core and the two different types of amorphous polyester resins are utilized in the shell. The shell resins generally do not comprise, and thus, are free of, the fluorescent agents. In addition, the shell resins are generally uncrosslinked.

The shell may be applied to the aggregated particles by using the shell resins in the form of emulsion(s) as described above. Such emulsions may be combined with the aggregated particles under conditions sufficient to form a coating over the aggregated particles. For example, the formation of the shell over the aggregated particles may occur while heating to a temperature of from about 30° C. to about 80° C. or from about 35° C. to about 70° C. The formation of the shell may take place for a period of time from about 5 minutes to about 10 hours or from about 10 minutes to about 5 hours.

Once the desired size of the toner particles is achieved, the pH of the mixture may be adjusted with a pH control agent, e.g., a base, to a value of from about 3 to about 10, or in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, a chelating agent such as ethylene diamine tetraacetic acid (EDTA) may be added to help adjust the pH to the desired values noted above. Other chelating agents may be used.

In embodiments, the size of the core-shell toner particles (prior to coalescence) may be from about 3 μm to about 10 μm, from about 4 μm to about 10 μm, or from about 6 μm to about 9 μm.

Coalescence

Following aggregation to the desired particle size and application of the shell (if any), the particles may then be coalesced to the desired final shape, the coalescence being achieved by, for example, heating the mixture to a temperature of from about 45° C. to about 150° C., from about 55° C. to about 99° C., or about 60° C. to about 90° C., which may be at or above the glass transition temperature of the resins utilized to form the toner particles. Heating may continue or the pH of the mixture may be adjusted (e.g., reduced) over a period of time to reach the desired circularity. The period of time may be from about 1 hours to about 5 hours or from about 2 hours to about 4 hours. Various buffers may be used during coalescence. The total time period for coalescence may be from about 1 to about 9 hours, from about 1 to about 8 hours, or from about 1 to about 5 hours. Stirring may be utilized during coalescence, for example, from about 20 rpm to about 1000 rpm or from about 30 rpm to about 800 rpm.

After aggregation and/or coalescence, the mixture may be cooled to room temperature. The cooling may be rapid or slow, as desired. A suitable cooling process may include introducing cold water to a jacket around the reactor. After cooling, the toner particles may be screened with a sieve of a desired size, filtered, washed with water, and then dried. Drying may be accomplished by any suitable process for drying including, for example, freeze-drying.

In the toner, the total amount of the fluorescent agents may be present in an amount of, for example, from 0.1 weight % to 10 weight % by weight of the toner. This includes a total amount of from 0.1 weight % to 8 weight % by weight of the toner, from 0.2 weight % to 6 weight % by weight of the toner, from 0.5 weight % to 5 weight % by weight of the toner, and from 1 weight % to 2 weight % by weight of the toner.

In the toner, a crystalline resin may be present, for example, in an amount of from 1 weight % to 85 weight % by weight of the toner, from 5 weight % to 50 weight % by weight of the toner, or from 10 weight % to 35 weight % by weight of the toner. An amorphous resin or combination of amorphous resins may be present, for example, in an amount of from 5 weight % to 95 weight % by weight of the toner, from 30 weight % to 90 weight % by weight of the toner, or from 35 weight % to 85 weight % by weight of the toner. In embodiments, crystalline and amorphous resins are used and the weight ratio of the resins is from 80 weight % to 60 weight % of the amorphous resin and from 20 weight % to 40 weight % of the crystalline resin. In such embodiments, the amorphous resin may be a combination of different types of amorphous resins, e.g., a combination of two different types of amorphous resins. In embodiments, one of the amorphous resins has an Mₙ or M_{w} that is greater than the other.

Other Additives

In embodiments, the toners may also contain other optional additives. For example, the toners may include positive or negative charge control agents. Surface additives may also be used. Examples of surface additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids such as zinc stearate, calcium stearate, and magnesium stearate, mixtures thereof and the like; long chain alcohols such as UNILIN 700; and mixtures thereof. Each of these surface additives may be present in an amount of from 0.1 weight % to 5 weight % by weight of the toner or from 0.25 weight % by weight to 3 weight % by weight of the toner.

Developers and Carriers

The toners may be formulated into a developer composition. Developer compositions can be prepared by mixing the toners with known carrier particles, including coated carriers, such as steel, ferrites, and the like. Such carriers include those disclosed in U.S. Pat. Nos. 4,937,166 and 4,935,326, the entire disclosures of each of which are incorporated herein by reference. The toners may be present in the carrier in amounts of from 1 weight % to 15 weight % by weight, from 2 weight % to 8 weight % by weight, or from 4 weight % to 6 weight % by weight. The carrier particles can also include a core with a polymer coating thereover, such as polymethylmethacrylate (PMMA), having dispersed therein a conductive component like conductive carbon black. Carrier coatings include silicone resins such as methyl silsesquioxanes, fluoropolymers such as polyvinylidiene fluoride, mixtures of resins not in close proximity in the triboelectric series such as polyvinylidiene fluoride and acrylics, thermosetting resins such as acrylics, mixtures thereof and other known components.

Applications

The toners may be used in a variety of xerographic processes and with a variety of xerographic printers. A xerographic imaging process includes, for example, preparing an image with a xerographic printer comprising a charging component, an imaging component, a photoconductive component, a developing component, a transfer component, and a fusing component. In embodiments, the development component may include a developer prepared by mixing a carrier with any of the toners described herein. The xerographic printer may be a high-speed printer, a black and white high-speed printer, a color printer, and the like. Once the image is formed with the toners/developers, the image may then be transferred to an image receiving medium such as paper and the like. Fuser roll members may be used to fuse the toner to the image-receiving medium by using heat and pressure. As noted above, an advantage of the present toners formed from the crosslinked fluorescent resin is that they prevent/minimize the contamination of such fuser rolls.

Inkjet Printing Compositions

Another illustrative composition that may be formed from the present crosslinked fluorescent latexes is an inkjet printing composition. Such compositions are configured to be jettable via an inkjet printing system. Such compositions may include any of the disclosed crosslinked fluorescent latexes, a solvent (such as water), optionally, a co-solvent (such as a water-soluble or water-miscible organic solvent), and optionally, an additive such as a surfactant, a viscosity modifier to adjust the viscosity of the inkjet printing composition, or a surface leveling agent to adjust the surface tension of the inkjet printing composition. The desired components may be combined and mixed in the desired amounts. The inkjet printing compositions may be used with commercially available inkjet printing systems. Illustrative solvents, co-solvents, additives, illustrative amounts, and illustrative inkjet printing systems include those as described in U.S. Pat. Pub. No. 20190367753 which is hereby incorporated by reference in its entirety. In using such inkjet printing compositions to form an image, the inkjet printing composition may be deposited on a desired substrate via an inkjet printing system. The solvent(s) may then be evaporated from the as-deposited inkjet printing composition.

### Example

The following Example is being submitted to illustrate various embodiments of the present disclosure. The Example is intended to be illustrative only and is not intended to limit the scope of the present disclosure. Also, parts and percentages are by weight unless otherwise indicated. As used throughout this patent specification, “room temperature” refers to a temperature of from 20° C. to 25° C.

Crosslinked fluorescent latexes were prepared as follows. First, an uncrosslinked fluorescent latex was prepared: a mixture of 200 g of an unsaturated amorphous polyester resin, and 4 g of a fluorescent agent was dissolved in a mixture of methyl ethyl ketone, isopropyl alcohol, water, and aqueous ammonia solution in a 2 L reactor at 55° C. Individual uncrosslinked fluorescent latexes were prepared using Fluorescent Brightener 184 and Solvent Yellow 160:1, respectively. In all cases, additional base solution (aqueous ammonia solution) was added to the mixture to completely neutralize the polyester resins. After an hour, deionized water was added to each mixture. The organic solvents were removed by applying a vacuum and water was added during this process to maintain the amount of desired water. Finally, the resulting emulsions were filtered through a 25 μm sieve. Emulsions had an average particle size of about 250 nm, and a solids content of about 30%. The total fluorescent agent content in each emulsion was about 1%. A surfactant (Calfax) and a biocide (Proxel GXL) were added to stabilize the uncrosslinked fluorescent latexes and prevent biogrowth.

To crosslink the fluorescent incorporated-resin particles and form the crosslinked fluorescent latexes, an ammonium persulfate (APS) solution (APS in water) was added to each uncrosslinked fluorescent latex at an amount of 1% by weight as compared to the weight of the resin in the uncrosslinked fluorescent latex. The mixture was heated to a temperature of about 90° C. for about 1.5 hours. The heating was carried out under an inert gas. These conditions were used to activate the initiator and induce the crosslinking reactions.

A comparative crosslinked fluorescent latex was prepared using Solvent Red 49 as the fluorescent agent and an oil-soluble initiator (an azo initiator, azobisisobutyronitrile (AIBN)). First, an uncrosslinked fluorescent latex were prepared as described above with the modification that the oil-soluble initiator was added before the removal of the organic solvents. Next, similar conditions were used to activate the initiator and induce the crosslinking reactions followed by removing organic solvents, adding water, filtering, and adding surfactant/biocide.

Other comparative uncrosslinked fluorescent latexes were prepared as described above with the modification that no initiator was added/no crosslinking was induced.

Rheology frequency sweep tests were conducted on the crosslinked fluorescent latexes using an ARES-G2 rheometer by TA instruments. The temperature was 120° C. and the frequency was swept from about 0.001 to about 1000.000 rad/sec. As described above, G′∝ωⁿ. The n values for three crosslinked fluorescent latexes are shown in Table 1, below. These were obtained for the linear portion of the frequency sweep from over 0.100 to 1.000 rad/sec.

TABLE 1
Rheology frequency sweep tests for crosslinked fluorescent latexes.

| | | | n |
|---|---|---|---|
| Sample | | Fluorescent Agent/Initiator | value |
| 1. | Crosslinked | Fluorescent Brightener 184 at 1.8 pph | 0.08 |
| | Fluorescent Latex - | APS at 1.5 pph | |
| | Water-soluble initiator | | |
| 2. | Crosslinked | Solvent Yellow 160:1 at 1.8 pph | 0.011 |
| | Fluorescent Latex - | APS at 1.5 pph | |
| | Water-soluble initiator | | |
| 3. | Crosslinked | Solvent Red 49 at 2.0 pph | 0.61 |
| | Fluorescent Latex - | AIBN at 0.75 pph | |
| | Oil-soluble initiator | | |

The results show that use of the water-soluble initiator leads to a degree of crosslinking that is from 7 to 55 times greater than using an oil-soluble initiator. In addition, the n values for Samples 1 and 2 show that the crosslinked resin particles are highly crosslinked.

Fluorescence was quantified using a spectrodensitometer and reflectance spectra were obtained. The results showed that the peak reflectance values for Samples 1 and 2 of Table 1 were within about ±1% that of each respective comparative sample using uncrosslinked fluorescent latex (i.e., same fluorescent latex but uncrosslinked). This confirms that the crosslinking process did not affect the fluorescence properties.

Finally, fluorescent toners were prepared from Samples 1 and 2 and xerographic printing tests conducted. The results showed that the life of the fuser roller member in the xerographic printing system was extended by at least 20% as compared to fluorescent toners prepared from uncrosslinked fluorescent latex. This reflects a significant reduction in contamination of the fuser roll due to the fluorescent agents.

It will be appreciated that variants of the above-disclosed and other features and functions or alternatives thereof, may be combined into many other different systems or applications. Various presently unforeseen or unanticipated alternatives, modifications, variations or improvements therein may be subsequently made by those skilled in the art, which are also intended to be encompassed by the following claims.

What is claimed is:

1. A method of making a crosslinked fluorescent latex, the method comprising:
adding a water-soluble initiator to an uncrosslinked fluorescent latex comprising water and uncrosslinked resin particles comprising an unsaturated resin and a fluorescent agent incorporated therein; and
exposing the water-soluble initiator to conditions to activate the water-soluble initiator and induce crosslinking reactions between the activated water-soluble initiator and the unsaturated resin, thereby forming a crosslinked fluorescent latex comprising crosslinked fluorescent resin particles comprising crosslinked resin and the fluorescent agent incorporated therein.

2. The method of claim 1, wherein the crosslinked fluorescent latex is characterized by a degree of crosslinking n of no more than 0.50 over range of frequencies from 0.100 to 1.000 rad/s as determined from a rheology sweep test at 120° C.

3. The method of claim 1, wherein the degree of crosslinking n is no more than 0.10.

4. The method of claim 1, wherein the crosslinked fluorescent latex is characterized by a peak reflectance value that is within ±2% of a peak reflectance value of the uncrosslinked fluorescent latex.

5. The method of claim 1, wherein the unsaturated resin is an unsaturated amorphous polyester resin.

6. The method of claim 1, wherein the water-soluble initiator has a solubility of more than 0.5 g/100 mL in water at 25° C.

7. The method of claim 1, wherein the water-soluble initiator is a persulfate.

8. A method of making a fluorescent toner, the method comprising:
forming a crosslinked fluorescent latex using the method of claim 1;
forming a mixture comprising the crosslinked fluorescent latex; a resin emulsion; and optionally, one or both of a wax dispersion and a colorant dispersion;
aggregating the mixture to form particles of a predetermined size; and
coalescing the particles to form a fluorescent toner.

9. The method of claim 8, wherein the resin emulsion comprises uncrosslinked resin.

10. A crosslinked fluorescent latex comprising water and crosslinked fluorescent resin particles comprising crosslinked resin and a fluorescent agent incorporated therein, wherein the crosslinked fluorescent latex is characterized by a degree of crosslinking n of no more than 0.50 over range of frequencies from 0.100 to 1.000 rad/s as determined from a rheology sweep test at 120° C.

11. The crosslinked fluorescent latex of claim 10, wherein the degree of crosslinking n is no more than 0.10.

12. The crosslinked fluorescent latex of claim 10, wherein the crosslinked fluorescent latex is characterized by a peak reflectance value that is within ±2% of a peak reflectance value of a comparative uncrosslinked fluorescent latex comprising water and uncrosslinked resin particles comprising an unsaturated resin and the fluorescent agent incorporated therein.

13. The crosslinked fluorescent latex of claim 10, wherein the crosslinked resin is an amorphous polyester resin.

14. A fluorescent toner comprising particles comprising uncrosslinked resin and crosslinked fluorescent resin particles comprising crosslinked resin and a fluorescent agent incorporated therein, wherein the crosslinked fluorescent resin particles are characterized by a degree of crosslinking n of no more than 0.50 over range of frequencies from 0.100 to 1.000 rad/s as determined from a rheology sweep test at 120° C.

15. A method of using the fluorescent toner of claim 14, the method comprising:
forming an image comprising the fluorescent toner using a xerographic printer;
transferring the image comprising the fluorescent toner to an image receiving medium; and
fusing the fluorescent toner to the image receiving medium.
